(19) United States
(12) Patent Application Publication
(10) Pub. No.: US 2013/0077341 A1
(43) Pub. Date: Mar. 28, 2013

(54) DISPLAY APPARATUS, BACKLIGHT DEVICE, AND LIGHT GUIDE DEVICE

(71) Applicants: Noriaki Kawai, Tokyo (JP); Takahisa Kaihotsu, Tokyo (JP)

(72) Inventors: Noriaki Kawai, Tokyo (JP); Takahisa Kaihotsu, Tokyo (JP)

(21) Appl. No.: 13/495,704

(22) Filed: Jun. 13, 2012

(30) Foreign Application Priority Data
Sep. 28, 2011 (JP) 2011-213182

(51) Int. Cl. F21V 7/04; G09F 13/04; F21V 8/00

(52) U.S. Cl. 362/602; 362/609

(57) ABSTRACT

According to one embodiment, a display apparatus includes a light source, a light guide module, a display panel, and a reflector between the light guide module and the display panel. Light irradiated by the light source enters the light guide module. The reflector is configured to transmit a part of the light exiting from the light guide module and to reflect a part thereof.

### CROSS REFERENCE TO RELATED APPLICATIONS

This application is based upon and claims the benefit of priority from the prior Japanese Patent Application No. 2011-213182, filed on Sep. 28, 2011, the entire contents of which are incorporated herein by reference.

### FIELD

Embodiments described herein relate generally to a display apparatus, a backlight device, and a light guide device.

### BACKGROUND

In recent years, liquid crystal displays (LCDs) have been widely used. A LCD includes a liquid crystal panel formed by interposing a liquid crystal material between two glass substrates, and a backlight device that illuminates the liquid crystal panel with light from the back face of the liquid crystal panel.

A backlight device of a direct-illumination type having light sources arranged in an array immediately below a liquid crystal panel illuminates the liquid crystal panel with light via a diffuser plate or the like that is positioned to face the liquid crystal panel. In such a system, to make the luminance of the liquid crystal panel uniform, the backlight device needs to be made thicker.

### BRIEF DESCRIPTION OF THE DRAWINGS

FIG. 1 is a schematic block diagram of an image display system having an image display apparatus 110 according to one embodiment.

FIG. 2 is a schematic block diagram of the display module 200.

FIG. 3 is a horizontal cross-sectional view of the backlight device 6 and the liquid crystal panel 1 according to the first embodiment.

FIG. 4 is a front view of the backlight device 6 and the liquid crystal panel 1.

FIG. 5 is a graph schematically showing the luminance of the liquid crystal panel 1 in the horizontal direction in a case where the reflecting layer 14 is not provided.

FIG. 6 is a back view of the reflecting layer 14, seen from the direction A shown in FIG. 3.

FIG. 7 is a bottom view of the reflecting layer 14, which is a modification example of FIG. 6.

FIG. 8 is a bottom view of the reflecting layer 14, which is another modification example of FIG. 6.

FIG. 9 is a horizontal cross-sectional view of a backlight device 6′ according to the second embodiment and the liquid crystal panel 1.

FIG. 10 is a graph schematically showing the luminance in the horizontal direction of the liquid crystal panel 1 in a case where a reflecting layer 14′ is not provided.

FIG. 11 is a back view of the reflecting layer 14′, seen from the direction B shown in FIG. 9.

### DETAILED DESCRIPTION

According to one embodiment, a display apparatus includes a light source, a light guide module, a display panel, and a reflector between the light guide module and the display module. Light irradiated by the light source enters the light guide module. The reflector is configured to transmit a part of the light exiting from the light guide module and to reflect a part thereof.

Embodiments will now be explained with reference to the accompanying drawings.

### First Embodiment

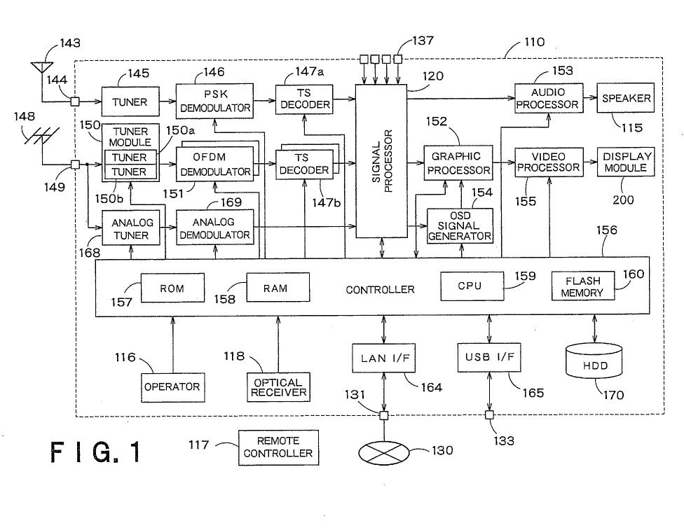

FIG. 1 is a schematic block diagram of an image display system having an image display apparatus 110 according to one embodiment.

The image display apparatus 110 has a controller 156 for controlling operations of each part, an operator 116, an optical receiver 118. The controller 156 has a ROM (Read Only Memory) 157, a RAM (Random Access Memory) 158, a CPU (Central Processing Unit) 159 and a flash memory 160.

The controller 156 activates a system control program and various processing programs stored in the ROM 157 in advance in accordance with an operation signal inputted from the operator 116 or inputted through the optical receiver 118 sent from the remote controller 117. The controller 156 controls the operations of each part according to the activated programs using the RAM 158 as a work memory of the CPU 159. Furthermore, the controller 156 stores and uses information and so on necessary for various settings in the flash memory 160 which is a non-volatile memory such as a NAND flash memory, for example.

The image display apparatus 110 further has an input terminal 144, a tuner 145, a PSK (Phase Shift Keying) demodulator 146, a TS (Transport Stream) decoder 147a and a signal processor 120.

The input terminal 144 sends a satellite digital television broadcasting signal received by an antenna 143 for receiving a BS/CS digital broadcast to the tuner 145 for the satellite digital broadcast. The tuner 145 tunes the received digital broadcasting signal to send the tuned digital broadcasting signal to the PSK demodulator 146. The PSK demodulator 146 demodulates the TS from the digital broadcasting signal to send the demodulated TS to the TS decoder 147a. The TS decoder 147a decodes the TS to a digital signal including a digital video signal, a digital audio signal and a data signal to send it to the signal processor 120.

Here, the digital video signal is a digital signal relating to a video which the image display apparatus 110 can output. The digital audio signal is a digital signal relating to an audio which the image display apparatus 110 can output. Furthermore, the data signal is a digital signal indicative of various kind of information about demodulated serves.

The image display apparatus 110 further has an input terminal 149, a tuner module having two tuners 150a and 150b, two OFDM (Orthogonal Frequency Division Multiplexing) demodulators 151, two TS decoders 147b, an analog tuner 168 and an analog demodulator 169.

The input terminal 149 sends a terrestrial digital television broadcasting signal received by an antenna 148 for receiving the terrestrial digital broadcast to the tuner 150 for the terrestrial digital broadcast. The tuners 150a and 150b in the tuner module 150 tune the received digital broadcasting signal to send the tuned digital broadcasting signal to the two OFDM demodulators 151, respectively. The OFDM demodulators 151 demodulate the TS from the digital broadcasting signal to send the demodulated TS to the corresponding TS decoder 147b. The TS decoder 147b decodes the TS to a digital video signal and a digital audio signal and so on to send them to the signal processor 120. The terrestrial digital television broadcast obtained by each of the tuners 150a and 150b in the tuner module 150 are decoded to the digital video signal, the digital audio signal and the digital signal including the data signal simultaneously by the two OFDM demodulators 151 and the TS decoders 147b, and then, can be sent to the signal processor 120.

The antenna 148 can also receive a terrestrial analog television broadcasting signal. The received terrestrial analog television broadcasting signal is divided by a divider (not shown) and sent to the analog tuner 168. The analog tuner 168 tunes the received analog broadcasting signal and sends the tuned analog broadcasting signal to the analog demodulator 169. The analog demodulator 169 demodulates the analog broadcasting signal to send the demodulated analog broadcasting signal to the signal processor 120. Furthermore, the image display apparatus 110 can display CATV (Common Antenna Television) by connecting a tuner for the CATV to the input terminal 149 connected to the antenna 148, for example.

The image display apparatus 110 further has a line input terminal 137, an audio processor 153, a speaker 115, a graphic processor 152, an OSD (On Screen Display) signal generator 154, a video processor 155 and a display 220.

The signal processor 120 performs a suitable signal processing on the digital signal sent from the TS decoders 147a and 147b or from the controller 156. More specifically, the signal processor 120 divides the digital signal into the digital video signal, the digital audio signal and the data signal. The digital video signal is sent to the graphic processor 152, and the divided digital audio signal is sent to the audio processor 153. Furthermore, the signal processor 120 converts the broadcasting signal sent from the analog demodulator 169 to a video signal and an audio signal in a predetermined digital format. The converted digital video signal is sent to the graphic processor 152, and the converted digital audio signal is sent to the audio processor 153. Furthermore, the signal processor 120 performs a digital signal processing on an input signal from the line input terminal 137.

The audio processor 153 converts the inputted audio signal to an analog audio signal in a format capable of being reproduced by the speaker 115. The analog audio signal is sent to the speaker 115 and is reproduced.

The OSD signal generator 154 generates an OSD signal for displaying an UI (User Interface) window or the like in accordance with a control of the controller 156. Furthermore, the data signal divided by the signal processor 120 from the digital broadcasting signal is converted to the OSD signal in a suitable format and is sent to the graphic processor 152.

The graphic processor 152 decodes the digital video signal sent from the signal processor 120. The decoded video signal is combined with the OSD signal sent from the OSD signal generator 154 and is sent to the video processor 155. The graphic processor 152 can send the decoded video signal or the OSD signal selectively to the video processor 155.

The video processor 155 converts the signal sent from the graphic processor 152 to an analog video signal in a format the display module 200 can display. The analog video signal is sent to the display module 200 to be displayed. The display module 200 is, for example, a crystal liquid display having a size of “12” inch or “20” inch.

The image display apparatus 110 further has a LAN

(Local Area Network) terminal 131, a LAN I/F (Interface) 164, a USB (Universal Serial Bus) terminal 133, a USB I/F 165 and a HDD (Hard Disk Drive) 170.

The LAN terminal 131 is connected to the controller 156 through the LAN I/F 164. The LAN terminal 131 is used as a general LAN-corresponding port using an Ethernet (registered trademark). In the present embodiment, a LAN cable is connected to the LAN terminal 131, and it is possible to communicate with an internet 130.

The USB terminal 133 is connected to the controller 156 through the USB I/F 165. The USB terminal 133 is used as a general USB-corresponding port. For example, a cellular phone, a digital camera, a card reader/writer for various memory cards, a HDD and a key board or the like can be connected to the USB terminal 133 through a hub. The controller 156 can communicate with devices connected through the USB terminal 133.

The HDD 170 is a magnetic storage medium in the image display apparatus 110, and has a function for storing various information of the image display apparatus 110.

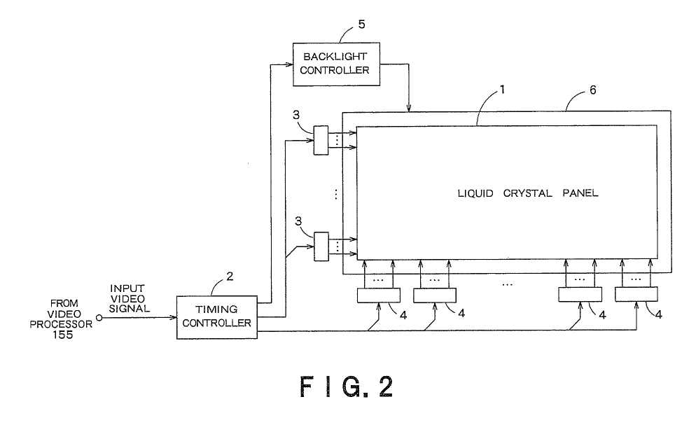

FIG. 2 is a schematic block diagram of the display module 200. The display module 200 has a liquid crystal panel (display panel) 1, a timing controller 2, a gate driver 3, a source driver 4, a backlight controller 5, and a backlight module 6.

The liquid crystal panel 1 has a structure where liquid crystal materials are put between a pair of facing glass substrates. The liquid crystal panel 1 has a plurality of (for example, “1080” of) scanning lines, a plurality of (for example, “1920*3” of) signal lines, and a plurality of liquid crystal pixels formed on each of crossing points of the scanning lines and the signal line.

The timing controller 2 provides the input video signal inputted from the video processor 155 of FIG. 1 to the source driver 4 and controls the operation timing of the gate driver 3, source driver 4 and backlight controller 5.

The gate driver 3 selects one of the scanning lines by turns. The source driver 4 provides the input video signal to the signal lines of the liquid crystal panel 1. The input video signal is provided to the liquid crystal pixel connected to the scanning line selected by the gate driver 3. According to the voltage of the supplied input video signal, alignments of the liquid crystal materials in the liquid crystal pixel vary. The gate driver 3 and the source driver 4 form a panel controller.

On the other hand, the backlight module 6 is arranged behind the liquid crystal panel 1 to irradiate light thereon. Among the irradiated light, light whose intensity depends on the alignments of the liquid crystal materials, is transmissive to the liquid crystal materials to be displayed on the liquid crystal panel 1.

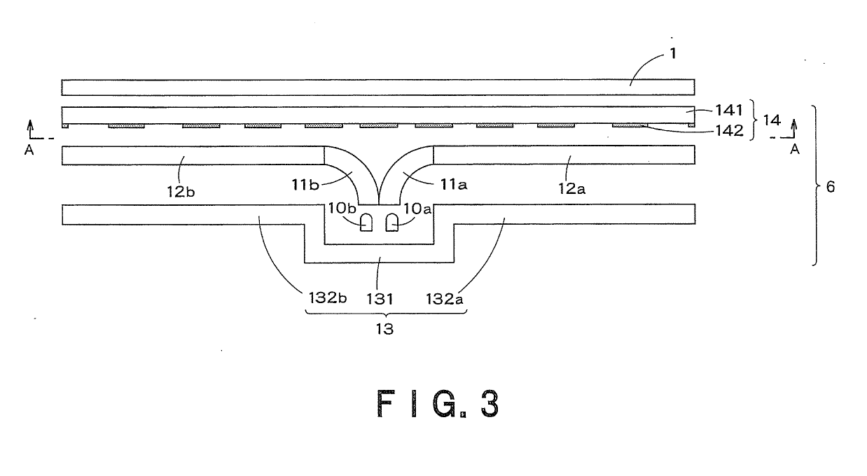

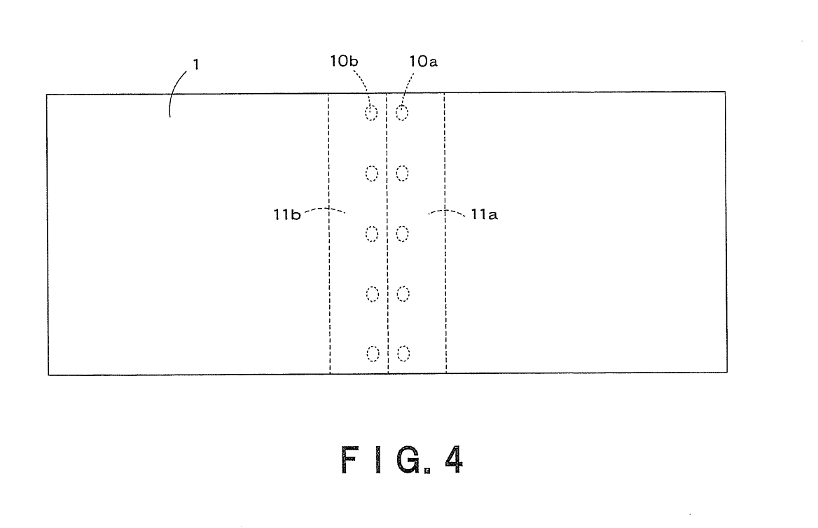

FIG. 3 is a horizontal cross-sectional view of the backlight device 6 and the liquid crystal panel 1 according to the first embodiment. FIG. 4 is a front view of the backlight device 6 and the liquid crystal panel 1. In FIG. 4, only some of the components are shown for simplicity. The backlight device 6 includes light sources 10a and 10b, waveguides 11a and 11b, light guide plates 12a and 12b, a reflecting plate 13, and a reflecting layer 14. The waveguides 11a and 11b, and the light guide plates 12a and 12b form a light guiding module. Since the respective components are provided in pairs in a symmetrical manner, one member with a suffix “a” of each pair will be mainly described.

The light sources 10a and 10b are point light sources such as LEDs. As shown in FIG. 4, the light sources 10a and 10b arranged in two rows are provided below a center portion of the liquid crystal panel 1 in the horizontal direction, with the two rows extending in the vertical direction of the liquid crystal panel 1. Most of the light emitted from the light sources 10a and 10b enters the waveguides 11a and 11b. However, part of the light does not enter the waveguides 11a and 11b, and travels directly toward the reflecting layer 14 and the liquid crystal panel 1 through the space between the waveguides 11a and 11b. As the light sources 10a and 10b are provided not at the edges of the liquid crystal panel 1 but below the liquid crystal panel 1, the bezel of the image display apparatus 110 can be made thinner.

The waveguide 11a has a shape like a light pipe, and includes an entrance face facing the light sources 10a, an exit face facing the light guide plate 12a, and a lightguide that guides light from the entrance face to the exit face and has a curved surface shape. The waveguide 11a is located between the light sources 10a and the center portion of the liquid crystal panel 1. The light that is emitted from the light sources 10a and enters through the entrance face reaches the exit face while diffusing in the waveguide 11a, and exits from the exit face to the light guide plate 12a.

The light guide plate 12a is made of acrylic and has a thickness of approximately 2 mm, for example. The light guide plate 12a is positioned to face a region of the liquid crystal panel 1 closer to the rim than the region the waveguide 11a faces. The light guide plate 12a may be made of the same material as that of the waveguide 11a, and be integrally formed with the waveguide 11a, so as to reduce the number of components. A diffuser (not shown) is applied by serigraph or the like to at least part of the lower face of the light guide plate 12a. The light that exits from the exit face of the waveguide 11a and enters the light guide plate 12a is scattered at the diffuser, and exits toward the liquid crystal panel 1 facing the light guide plate 12a. By controlling the density of the diffuser, unevenness of the luminance of the light illuminating the liquid crystal panel 1 can be restrained.

The reflecting plate 13 includes: a first reflecting face 131 that surrounds the ends of the light sources 10a and 10b opposite from the light emitting ends, and sides of the light sources 10a and 10b; and second reflecting faces 132a and 132b that face the surfaces of the light guide plates 12a and 12b opposite from the liquid crystal panel 1. The reflecting plate 13 reflects the light that exits from the light guide plates 12a and 12b and travels in the opposite direction from the liquid crystal panel 1, and the light that is reflected by the later described reflecting layer 14 and travels in the opposite direction from the liquid crystal panel 1, toward the liquid crystal panel 1, thereby increasing efficiency of light use.

The reflecting layer 14 includes: a transparent plate 141 that has high transparency and allows light to pass therethrough; and a reflecting member (or a scattering member) 142 that reflects (or scatters) light. The reflecting layer 14 is provided between the liquid crystal panel 1, and the waveguides 11a an 11b and the light guide plates 12a and 12b.

The transparent plate 141 is made of PMMA (polymethylmethacrylate), PET (polyethylene terephthalate), PC (polycarbonate), or the like. The transparent plate 141 may contain beads or the like to have not only a light transmitting function but also a diffusing function. In this manner, unevenness of the luminance of the light illuminating the liquid crystal panel 1 may be restrained. The reflecting member 142 is a reflective material such as serigraph on the back face (or the front face) of the transparent plate 141, for example.

The light that exits from the light guide plate 12a and travels toward the liquid crystal panel 1 is reflected at the locations where the reflecting member 142 is provided, but passes through the transparent plate 141 at the locations where the reflecting member 142 is not provided, and reaches the liquid crystal panel 1. That is, the locations where the reflecting member 142 is not provided serve as openings to allow the light to pass therethrough. The reflecting member 142 is provided in the following manner, so that the luminance of the liquid crystal panel 1 becomes uniform.

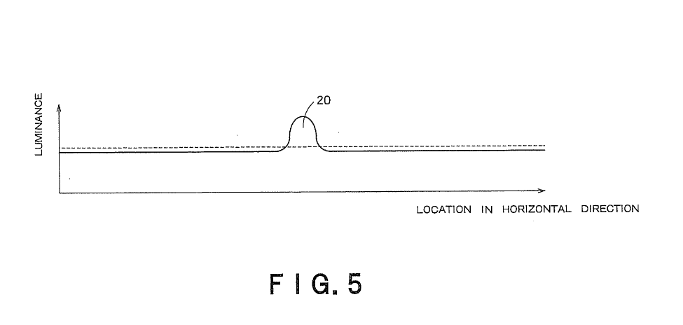

FIG. 5 is a graph schematically showing the luminance of the liquid crystal panel 1 in the horizontal direction in a case where the reflecting layer 14 is not provided. In the graph, the horizontal axis indicates the location in the horizontal direction, and the vertical axis indicates the luminance. As indicated by the solid line in the graph, a luminance peak 20 appears only at the center portion of the liquid crystal panel 1 in the horizontal direction. This is because part of the light emitted from the light sources 10a and 10b does not enter the waveguides 11a and 11b, but leaks through a space between the waveguides 11a and 11b to directly reach the liquid crystal panel 1.

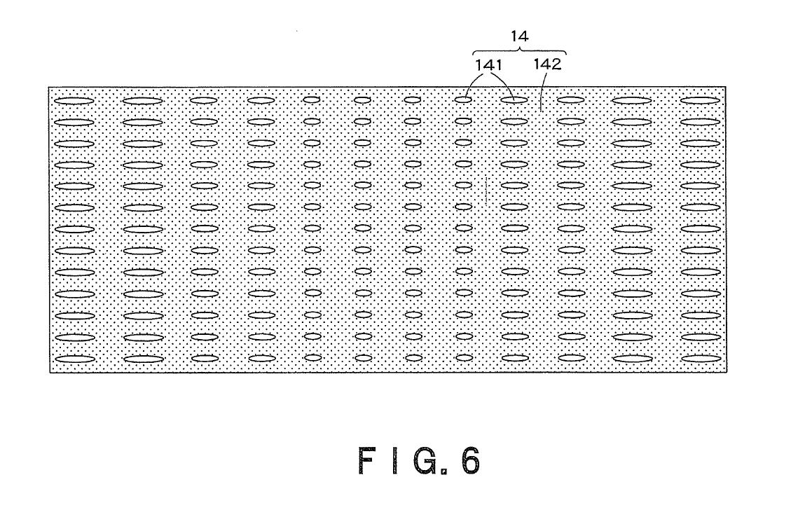

To counter this problem, the present embodiment intends to uniform the luminance by using the reflecting layer 14. FIG. 6 is a back view of the reflecting layer 14, seen from the direction A shown in FIG. 3. As shown in the drawing, in the vicinity of the horizontal center facing the space between the waveguides 11a and 11b, the regions where the reflecting member 142 is printed are made wider, and the openings are made narrower. The shape of each of the openings is circular or ellipsoidal, and the smallest diameter is 10 to 20 μm, for example. With this arrangement, the transmission rate in the region corresponding to the luminance peak 20 shown in FIG. 5 becomes lower than a predetermined value, thereby restraining appearance of peaks.

Further, the openings have larger diameters in regions closer to the rims from the position of the reflecting layer 14 facing the space between the waveguides 11a and 11b. In other words, the region where the reflecting member 142 is printed is made narrower. With this arrangement, the transmission rates of the reflecting layer 14 become higher toward the rims, thereby scattering the luminance peak 20 in the entire liquid crystal panel 1.

As a result, luminance unevenness in the liquid crystal panel 1 can be restrained, and the luminance can be made uniform, as indicated by the dotted line in FIG. 5.

As shown in FIG. 4, the light sources 10a and 10b are aligned in the vertical direction, and the light diffused in the waveguides 11a and 11b reaches the liquid crystal panel 1. Therefore, the luminance of the liquid crystal panel 1 in the vertical direction is substantially uniform. In this case, the shape of the reflecting member 142 does not need to be varied between the center portion in the vertical direction and the rim portions.

In a case of realizing the same structure as that of FIG. 3 in a backlight device of a so-called direct-illumination type in which the waveguides 11a and 11b and the light guide plates 12a and 12b are not provided, the openings in the reflecting layer should be made very small. However, it is difficult to form such small openings with high precision by printing. Therefore, with the limit of printing precision being taken into consideration, the distance between each light source and the reflecting layer 14 needs to be long enough to diffuse light. As a result, the backlight device becomes thicker.

In this embodiment, on the other hand, the so-called “entrance length” for diffusing light is sufficiently secured by the waveguides 11a and 11b. Accordingly, even if the backlight device 6 is made thinner, the luminance of the liquid crystal panel 1 can be made uniform without forming so small openings in the reflecting layer 14.

As described above, since the reflecting layer 14 having transmission rates varying with locations is provided in the first embodiment, the liquid crystal panel 1 can be uniformly illuminated. Further, by arranging the light sources 10a and 10b below the liquid crystal panel 1, the bezel can be made thinner. Even when the light sources 10a and 10b are arranged as described above, the light sufficiently diffuses in the waveguides 11a and 11b in the vertical direction of the liquid crystal panel 1. Accordingly, the backlight device 6 can be made thinner than a backlight device of a direct-illumination type.

In the following, some modification examples of the structure illustrated in FIG. 6 are described. It is enough that the reflecting layer 14 has higher transmission rates in regions closer to the rims than to the center portion in the horizontal direction. For example, the reflecting member 142 is formed so that the openings have larger diameters in regions closer to the rims in FIG. 6. However, the diameters may be made uniform, and the densities of the openings may be varied. Alternatively, the openings do not need to have circular or ellipsoidal shapes, but may have any other shapes such as triangular shapes, rectangular shapes, or hexagonal shapes.

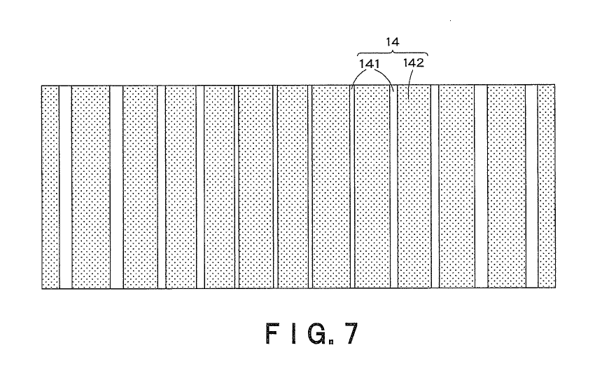

Also, as shown in FIG. 7, linear openings may be formed. In this case, reflecting members 142 may be formed so that the widths of the lines become wider toward the rims. Alternatively, the reflecting members 142 may be formed so that the density of the linear openings becomes higher toward the rims, in other word, the opening pitch becomes narrower toward the rims.

Further, the reflecting member 142 is formed on the transparent plate 141 in the example described in this embodiment. However, holes may be formed as the openings in a plate made of a reflective or diffusive material, so that transmission rates (or reflection rates) depending on locations in the horizontal direction may be realized.

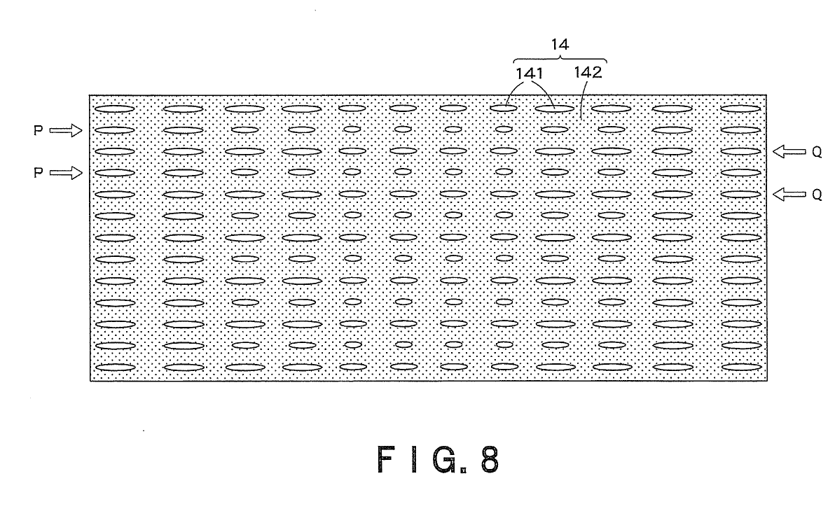

If the backlight device 6 is made even thinner and the waveguides 11a and 11b are made shorter, there is a probability that luminance unevenness may appear in the vertical direction of the liquid crystal panel 1. In this case, the transmission rates of the reflecting layer 14 may be controlled depending on the locations in the vertical direction, as shown in FIG. 8. For example, the openings at locations (indicated by arrows P) where the light sources 10a and 10b are provided may be made smaller, and the openings at the locations (indicated by arrows Q) where the light sources 10a and 10b are not provided may be made larger.

### Second Embodiment

In the above described first embodiment, the light emitted from the light sources 10a and 10b is guided to the light guide plates 12a and 12b by the waveguides 11a and 11b having shapes like light pipes. In a second embodiment described below, on the other hand, waveguides having shapes like triangular prisms are used.

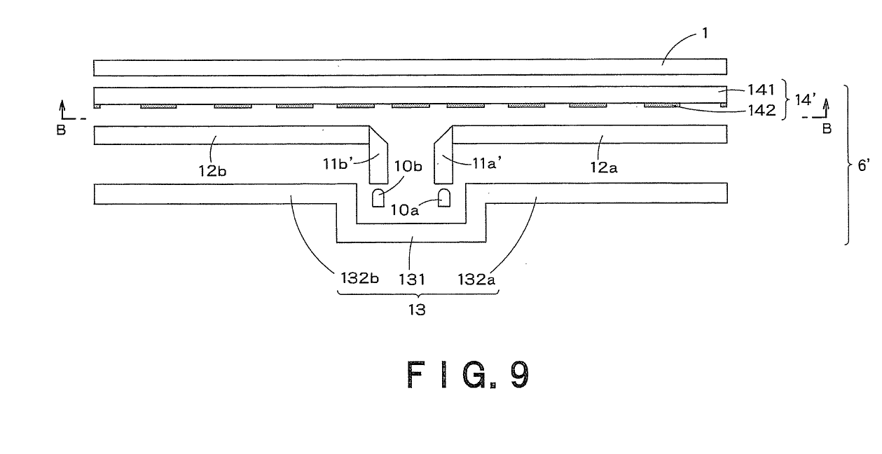

FIG. 9 is a horizontal cross-sectional view of a backlight device 6′ according to the second embodiment and the liquid crystal panel 1. The same components as those shown in FIG. 3 are denoted by the same reference numerals as those used in FIG. 3, and different aspects are mainly described in the following.

The backlight device 6′ shown in FIG. 9 includes waveguides 11a′ and 11b′ having shapes like triangular prisms, instead of the waveguides 11a and 11b having shapes like light pipes. The waveguide 11a′ includes an entrance face facing the light sources 10a, and a reflection face that is tilted at approximately 45 degrees with respect to the light entrance direction and deflects light toward the light guide plate 12a.

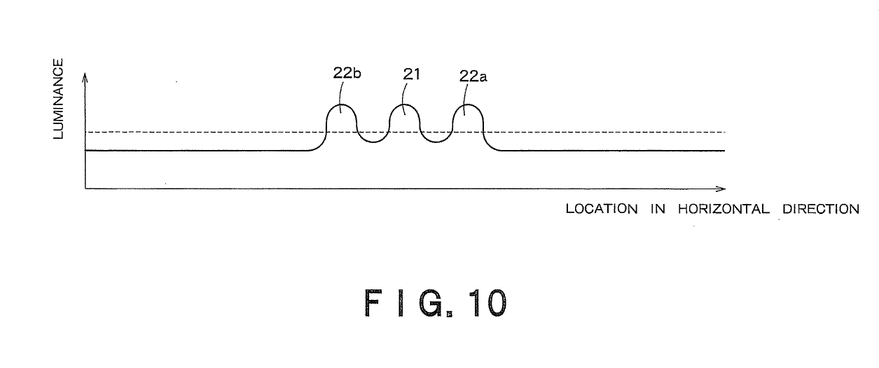

FIG. 10 is a graph schematically showing the luminance in the horizontal direction of the liquid crystal panel 1 in a case where a reflecting layer 14′ is not provided. In the graph, the horizontal axis indicates locations in the horizontal direction, and the vertical axis indicates luminance. As shown by the solid line in the graph, three luminance peaks 21, 22a, and 22b appear. The luminance peak 21 appears because part of the light emitted from the light sources 10a and 10b does not enter the waveguides 11a′ and 11b′, and leaks through a space between the waveguides 11a′ and 11b′ to directly reach the liquid crystal panel 1. The luminance peaks 22a and 22b appear because light leaks through the respective connecting portions between the waveguides 11a′ and 11b′ and the light guide plates 12a and 12b to reach the liquid crystal panel 1.

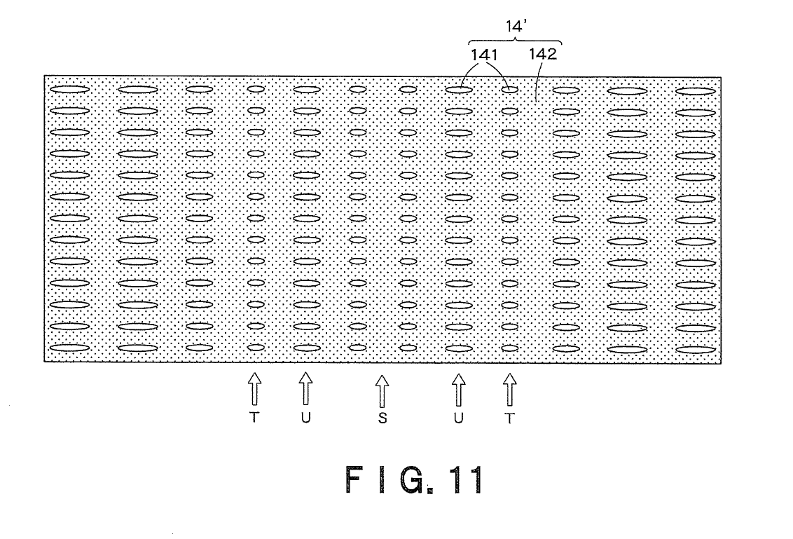

To counter this problem, the present embodiment intends to uniform the luminance by using the reflecting layer 14′. FIG. 11 is a back view of the reflecting layer 14′, seen from the direction B shown in FIG. 9.

As shown in the drawing, in order to restrain the peak 21, the diameters of the openings in the reflecting member 142 are made smaller at locations (indicated by an arrow S) facing the space between the waveguide 11a′ and the waveguide 11b′. Likewise, in order to restrain the peaks 22a and 22b, the diameters of the openings are also made smaller at locations (indicated by arrows T) facing the connecting portion between the waveguide 11a′ and the light guide plate 12a, and the connecting portion between the waveguide 11a′ and the light guide plate 12b. At the locations (indicated by arrows U) facing the waveguides 11a′ and 11b′, on the other hand, the diameters of the openings are made relatively large. With this arrangement, the transmission rates in the regions corresponding to the peaks 21, 22a, and 22b shown in FIG. 10 become lower than a predetermined value, and the transmission rates in the regions corresponding to the zone between the peaks 21 and 22a and the zone between the peak 21 and 22b become higher than the predetermined value, thereby restraining appearance of peaks.

Further, outside the regions (indicated by the arrows T) facing the connecting portion between the waveguide 11a′ and the light guide plate 12a and the connecting portion between the waveguide 11b′ and the light guide plate 12b, the diameters of the openings are made larger toward. the rims. With this arrangement, the transmission rates of the reflecting layer 14′ become higher toward the rims, and the luminance peaks 21, 22a, and 22b can be uniformly scattered in the entire liquid crystal panel 1.

As a result, luminance unevenness in the liquid crystal panel 1 can be restrained, and the luminance can be made uniform, as indicated by the dotted line in FIG. 10.

As described above, in the second embodiment, the reflecting layer 14′ having transmission rates varying with locations is provided. Accordingly, the liquid crystal panel 1 can be uniformly illuminated.

In the second embodiment, as shown in FIG. 7 or FIG. 8, a reflecting member 142 having different shapes from those shown in FIG. 10 may of course be formed so as to adjust the transmission rates of the reflecting layer 14′.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and spirit of the inventions.

1. A display apparatus comprising:
a light source;
a light guide module light irradiated by the light source enters;
a display panel; and
a reflector between the light guide module and the display panel, the reflector being configured to transmit a part of the light exiting from the light guide module and to reflect a part thereof.

2. The apparatus of claim 1, wherein the reflector is configured to transmit the part of the light irradiated from the light source and to reflect the part thereof in such a manner that luminance of the display panel become uniform.

3. The apparatus of claim 1, wherein the light source is provided facing a first side of the display panel, the first side being opposite from the reflector.

4. The apparatus of claim 3, wherein the light source comprises:
a first light source; and
a second light source at a position different from a position of the first light source,
the light guide module comprises:
a first waveguide configured to deflect the light toward a first rim side of the reflector along the reflector, the light being irradiated from the first light source to the reflector;
a first light guide plate configured to output the light toward the reflector, the light being inputted from the first waveguide;
a second waveguide configured to deflect the light toward a second rim side of the reflector along the reflector, the light being irradiated from the second light source to the reflector, the second rim side facing the first rim side; and
a second light guide plate configured to output the light toward the reflector, the light being inputted from the second waveguide.

5. The apparatus of claim 4, wherein a first transmission rate is lower than a second transmission rate and a third transmission rate,
the first transmission rate being a transmission rate at a region facing a region between the first waveguide and the second waveguide,
the second transmission rate being a transmission rate at a region closer the first rim side than a region facing the first waveguide, and
the third transmission rate being a transmission rate at a region closer the second rim side than a region facing the second waveguide of the reflector.

6. The apparatus of claim 4, wherein at a region closer to the first rim side than a region facing the first waveguide and a region closer to the second rim side than a region facing the second waveguide, a transmission rate becomes higher toward the first rim side and the second rim side.

7. The apparatus of claim 4, a first transmission rate is lower than a second transmission rate,
the first transmission rate being a transmission rate at a region facing a connecting portions between the first waveguide and the first light guide plate,
the second transmission rate being a transmission rate at a region facing the first waveguide, and
a third transmission rate is lower than a fourth transmission rate,
the third transmission rate being a transmission rate at a region facing a connecting portions between the second waveguide and the second light guide plate,
the fourth transmission rate being a transmission rate at a region facing the second waveguide.

8. The apparatus of claim 1, wherein the reflector comprises:
a transparent plate through which the light is transparent; and
a reflecting member at a part of the transparent plate, the reflection member being configured to reflect the light,
wherein a transmission rate of the reflecting member is adjusted according to a shape of the reflecting member.

9. The apparatus of claim 1 further comprising a reflecting plate configured to reflect the light reflected at the reflector toward the reflector.

10. The apparatus of claim 1 further comprising a tuner configured to receive and tune a broadcast wave,
wherein the display is configured to display the tuned broadcast wave.

11. A backlight device comprising:
a light source;
a light guide module light irradiated by the light source enters;
a reflector configured to transmit a part of the light exiting from the light guide module and to reflect a part thereof.

12. The device of claim 11, wherein the reflector is configured to transmit the part of the light irradiated from the light source and to reflect the part thereof in such a manner that luminance of a display panel become uniform, the display panel being provided facing a first side of the light guide module, the first side being opposite from the reflector.

13. The device of claim 11, wherein the light source is provided facing a first side of the display panel, the first side being opposite from the reflector.

14. The device of claim 13, wherein the light source comprises:
a first light source; and
a second light source at a position different from a position of the first light source,
the light guide module comprises:
a first waveguide configured to deflect the light toward a first rim side of the reflector along the reflector, the light being irradiated from the first light source to the reflector;
a first light guide plate configured to output the light toward the reflector, the light being inputted from the first waveguide;
a second waveguide configured to deflect the light toward a second rim side of the reflector along the reflector, the light being irradiated from the second light source to the reflector, the second rim side facing the first rim side; and
a second light guide plate configured to output the light toward the reflector, the light being inputted from the second waveguide.

15. The device of claim 14, wherein a first transmission rate is lower than a second transmission rate and a third transmission rate,
the first transmission rate being a transmission rate at a region facing a region between the first waveguide and the second waveguide of the reflector,
the second transmission rate being a transmission rate at a region closer the first rim side than a region facing the first waveguide, and
the third transmission rate being a transmission rate at a region closer the second rim side than a region facing the second waveguide.

16. The device of claim 14, wherein at a region closer to the first rim side than a region facing the first waveguide and a region closer to the second rim side than a region facing the second waveguide, a transmission rate becomes higher toward the first rim side and the second rim side.

17. The device of claim 14, a first transmission rate is lower than a second transmission rate,
the first transmission rate being a transmission rate at a region facing a connecting portions between the first waveguide and the first light guide plate,
the second transmission rate being a transmission rate at a region facing the first waveguide, and
a third transmission rate is lower than a fourth transmission rate,
the third transmission rate being a transmission rate at a region facing a connecting portions between the second waveguide and the second light guide plate,
the fourth transmission rate being a transmission rate at a region facing the second waveguide.

18. The device of claim 11, wherein the reflector comprises:
a transparent plate through which the light is transparent; and
a reflecting member at a part of the transparent plate, the reflection member being configured to reflect the light,
wherein a transmission rate of the reflecting member is adjusted according to a shape of the reflecting member.

19. The device of claim 11 further comprising a reflecting plate configured to reflect the light reflected at the reflector toward the reflector.

20. A light guide device used for a backlight device, the light guide device comprising:
a light guide module light irradiated by a light source enters; and
a reflector configured to transmit a part of the light exiting from the light guide module and to reflect a part thereof.
